(19) United States
(12) Patent Application Publication
(10) Pub. No.: US 2001/0037198 A1
(43) Pub. Date: Nov. 1, 2001

(54) Method and system for providing texts for voice requests

(75) Inventor: I-Cheng Chen, Sunnyvale, CA (US)

Correspondence Address: SILICON VALLEY PATENT AGENCY, INC., 7394 WILDFLOWER WAY, CUPERTINO, CA, 95014, US

(73) Assignee: Into Voice Corporation, Sunnyvale, CA

(21) Appl. No.: 09/775,044

(22) Filed: Jan. 31, 2001

Related U.S. Application Data
(60) Provisional application No. 60/179,710, filed on Feb. 1, 2000.
(60) Provisional application No. 60/179,709, filed on Feb. 1, 2000.

(51) Int. Cl. G10L 15/26

(52) U.S. Cl. 704/235

(57) ABSTRACT

Methods and systems for providing texts for voice requests are disclosed. According to one embodiment, an audio signal is received from a caller. The audio signal is speech-recognized to produce a spoken text that contains one or more key words referring to a piece of information interesting to the caller. The key words are processed with a local search data set to formulate an identifier linking to the information that may be locally or remotely obtainable. As a result, a caller is relieved from an otherwise strict requirement that the caller has to speak every single word of an identifier of a piece of information.

### CROSS-REFERENCE TO RELATED APPLICATION

This application claims the benefits of the provisional applications, Ser. No. 60/179,710, entitled “Method and System for Mapping Spoken Text to Standard Text”, Ser. No. 60/179,709, entitled “Method and System for Dynamically Configuring Grammars”, both filed on Feb. 1, 2000, which are hereby incorporated by reference for all purposes.

### BACKGROUND OF THE INVENTION

1. Field of the Invention

The present invention generally relates to the area of voice interactive technologies and more particularly relates to a method and a system for mapping a spoken text to a standard text identifying a piece of detailed information, wherein the spoken text is generally a short or verbal version of what is meant for the standard text. The present invention also relates to a method and a system for locally archiving information that is currently or potentially highly demanded by users and minimizing ambiguities between two words/phrases that might be pronounced indistinctly.

2. Background of Related Art

The Internet is a rapidly growing communication network of interconnected computers and computer networks around the world. Together, these millions of connected computers form a repository of multimedia information that is readily accessible by any of the connected computers from anywhere at any time. In order to provide mobility and portable access to the World Wide Web, many portable devices are introduced to provide connectivity to the World Wide Web. Most of such portable devices, such as mobile phones and palm computers, however, do not provide a full capacity of user interfaces such as a large display screen, a stereo sound system and a full functional keyboard. Although some type of automatic or assisted key-in methods have been developed to facilitate the data entry to the portable devices, at the same time, problems resulted from such developments have been introduced unexpectedly. For example, a user of such portable device has to look at the tiny screen while entering data. When the user is driving a car, such interaction with a portable device would likely cause accidents because the interaction essentially takes the user's eyes off the steering wheel. In fact, many states in US are considering legislative measures to regulate the use of such portable devices which operating a vehicle.

On the other side, the use of a portable device while driving is still popular because the portable device provides useful information for a driver. For example, a driver could get directional, traffic and weather information of a selected city or a route from the portable device communicating with the Internet. In additional, the driver may desire to be in touch with his/her contacts through emails while on the go. It has been a dilemma between providing an information assistant and potentially causing traffic accidents while operating a vehicle. Thus many considerations and factors have prompted the adoption of voice interactive services that permit voice interactions with a portable device. Assisted by a voice recognition system, a user can simply speak to the device and listen to requested information.

One problem with the voice interactive services is that a user has to speak clearly and completely so that a proxy server would understand what exactly the user is looking for. When it comes to information identified by a long name consisting of multiple words, it would be tedious and awkward to speak each of the multiple words. There is thus a need for a generic solution that accommodates spoken words that are typically a shortened version of a lone name identifying the desired information.

In voice interactive systems, it is desirable to provide desired information upon receiving a request. The requested information is typically hosted in a server remotely located and communicated over a network. To respond to the request, the requested information will be fetched from the server over the network and subsequently delivered to a user who has made the request. In many situations, a piece of particular information is so demanding that repeated requests are received therefor, which causes repeated fetching of the same information over the network. The voice interactive systems could suffer from lack of computing resources that have to be allocated to timely fulfill the repeated requests and at the same time cause tremendous network traffics in the network. There is thus another need for a voice interactive system to provide a solution that can fulfill the repeated requests timely without affecting system performance and causing traffics to the network.

Still there are many words that might be pronounced indifferently from other words, hence causing retrieval of incorrect information. There is yet another need for a voice interactive system to provide a mechanism that can minimize ambiguities between two words, phrases, symbols, identifiers that might be pronounced indistinctly.

### SUMMARY OF THE INVENTION

The present invention has been made in consideration of the above described problems and needs and has particular applications to voice interactive systems and applications. According to one aspect of the present invention, an audio signal is received from a caller. The audio signal is speech-recognized to produce a spoken text that contains one or more key words referring to a piece of information interesting to the caller. The key words are locally processed with a local search data set to formulate an identifier linking to the information that may be locally or remotely obtainable. As a result, a caller is relieved from an otherwise strict requirement that the caller has to speak every single word of an identifier of a piece of information. As used herein, an identifier includes one or more words and is used as a label, a symbol, an icon, a file name or a representation of a piece of information. Generally a correct identifier must be provided, the information can be located among many categories or kinds of information.

According to another aspect of the invention, a local search data is generated from a group of identifiers, each of the identifiers pointing to a piece of information. A histogram is computed from the group of identifiers to determine a generic words group and a key words group. The generic words group includes words that may be interpreted as so generic and add very little information an identifier under an information category. Oppositely, the key words group includes words that may be interpreted as so specific and what could be included in a spoken text from a caller. The local search data is then formed by words in the key words group. When a spoken text is received, words in the spoken text are processed to find the corresponding key words in the local search data. Once the searched key words are obtained, the identifier comprising the searched key words is obtained. Hence the information identified by the identifier can be retrieved locally or fetched remotely.

According to yet another aspect of the present invention, the received requests from callers for information are being monitored. When a counter of an identifier being requested many times in a predetermined period, the counter exceeds a threshold. The identifier is entered into a local information reservoir. The local information reservoir hosts the information that is highly demanding by the callers. To keep the information updated, the information reservoir is configured to update the information automatically with a source thereof. As a result, requests for the highly demanded information could be fulfilled locally and contributions to the network traffics could be minimized.

According to still another aspect of the present invention, another use of the counter is to mark an identifier when the designated counter exceeds a threshold. The purpose of marking a highly demanded identifier (a piece of associated information) is to minimize ambiguities between two identifiers that might be pronounced indistinctly.

According to still another aspect of the present invention, an identifier can be added into the local information reservoir to anticipate high demanding thereof. In situations in which callers may demand a piece of particular information as soon as an event starts or ends, an identifier of the particular information is initially added into the local information reservoir regardless how many of requests for the information are received. Thus callers can get the information locally or as soon as it becomes available.

The invention may be implemented as a method, an apparatus, a system or a software product. The processes, sequences or steps and features disclosed in the present invention are related to each other and each is believed independently novel in the art. The disclosed processes, sequences or steps and features may be performed alone or in any combination to provide a novel and unobvious system or a portion of a system.

Accordingly, it is one of the objects of the present invention to provide a solution for mapping a spoken text to a standard text identifying a piece of detailed information. It is another one of the objects of the present invention to provide a method and a system for locally archiving information that is currently or potentially highly demanded by users. It is still another one of the objects of the present invention to provide a mechanism to minimize ambiguities between two words, phrases, identifiers, symbols that might be pronounced indistinctly

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 illustrates an exemplary configuration in which the present invention may be practiced;

FIG. 2A illustrates a functional block diagram of an information server according to one embodiment of the present invention;

FIG. 2B shows a block diagram of a preferred internal construction of a computer system that may be used to implement the present invention or facilitate the applications of the present invention;

FIG. 3A illustrates an exemplary information reservoir according to one embodiment of the present invention;

FIG. 3B illustrates a diagram of counter vs. time to demonstrate when an identifier is to be entered into a local information reservoir;

FIG. 3C shows an example of an identifier being entered into a local information reservoir to anticipate high demands of the information;

FIG. 4A shows a flowchart of a process implementing archiving information in a local information reservoir according to one embodiment of the present invention;

FIG. 4B shows a flowchart of a process that can be implemented to minimize ambiguities between two identifiers that might be pronounced indistinctly;

FIG. 5A shows a functional diagram of generating an identifier from spoken words by a caller;

FIG. 5B illustrates an example in which the spoken words are “Paolo's in Sunnyvale” and the final identifier is “PAOLO'S RESTAURANT”;

FIG. 6A shows a flowchart of a process of generating a local searching data set;

FIG. 6B shows a histogram computed from a group of identifiers, each including one or more words or symbols;

FIG. 6C shows a group of identifiers under a restaurant category;

FIG. 6D shows a histogram computed from a group of identifiers in FIG. 6C;

FIG. 6E shows an identifier “The Texas Fish and Chips Food” reformatted from “The Texas Fish & Chips Food”;

FIG. 6F shows an exemplary portion of a tree structure for keywords of the identifiers in FIG. 6C;

FIG. 6G shows a key word possibly leads to two other key words; and

FIG. 6H shows an identifier is reconstructed from a number of key words.

### DETAILED DESCRIPTION OF THE PREFERRED EMBODIMENTS

In the following detailed description of the present invention, numerous specific details are set forth in order to provide a thorough understanding of the present invention. However, it will become obvious to those skilled in the art that the present invention may be practiced without these specific details. In other instances, well known methods, procedures, components, and circuitry have not been described in detail to avoid unnecessarily obscuring aspects of the present invention. The detailed description is presented largely in terms of procedures, logic blocks, processing, and other symbolic representations that directly or indirectly resemble the operations of data processing devices coupled to networks. These process descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

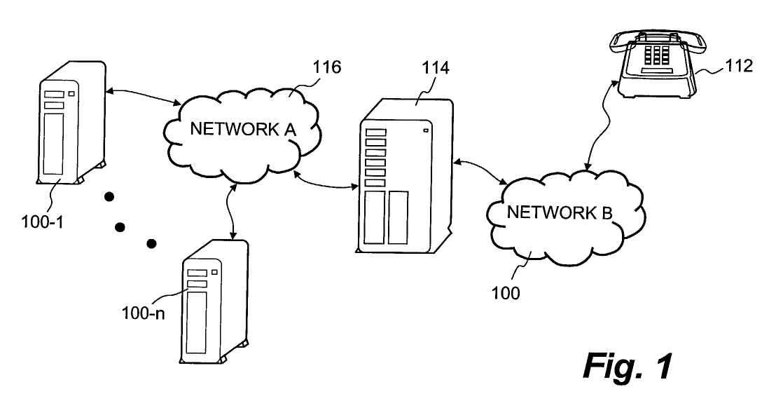

Referring now to the drawings, in which like numerals refer to like parts throughout the several views. FIG. 1 illustrates an exemplary configuration in which the present invention may be practiced. Network 100 is a telephone network that may include, but not be limited to, a public switched telephone network (PSTN) and a wireless network. Phone 112 may represent one of numerous telephonic devices on network 100 and communicate with an information gateway 114 coupled between network 100 and data network 116. Examples of the telephonic devices may include, but not be limited to, a landline telephone, a mobile phone or a computing device with telephone functions.

Information gateway 114, also knows voice interactive server, voice server or proxy server, functions as a telephonic device and a data server. As a telephonic device, information gateway 114 operates on a telephone network (e.g. 100) and is assigned to a telephone number (e.g. in US: 1-800-121-1515) and thus can communicate with any of telephonic devices on the network. In other words, a telephone on a telephone network can dial in the telephone number of information gateway 114 to establish a voice link. As a result, a user of the telephone from anywhere can interact with information gateway 114 to obtain desired information, for example, from the Internet.

Data network 116 may be the Internet, the Intranet or a network of a private and a public network. Coupled thereon there are a number of server devices 100, each providing pertinent information for other computing device to retrieve therefrom. For example, server 100-1 is a stock quote server, e.g. www.quotes.com, providing delayed or real-time stock quote information. Server 100-n is a news feeding server providing updated national or worldwide news to general public. As used herein, each of server devices 100 is interchangeably referred to as a feeding server, a source server, a source provider or simply a server. Generally, a source server hosts a plurality of information, each piece of the information is identified by a file name, an entry in a table or in a database and may be organized in accordance with a category. The file name may include one or more words or symbols. To fetch a piece of information, a network request must be received from another computing device (e.g. information server 114). The network request shall include a file name to identify the information being requested. In response to the network request, the source server is configured to release the information that are transported over the network.

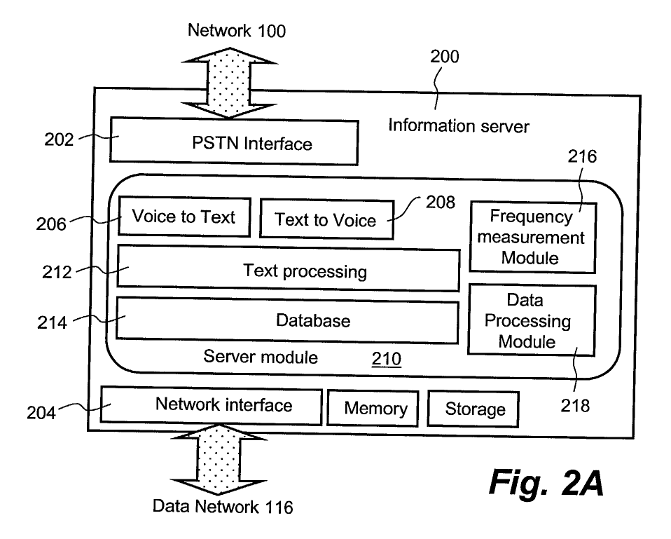

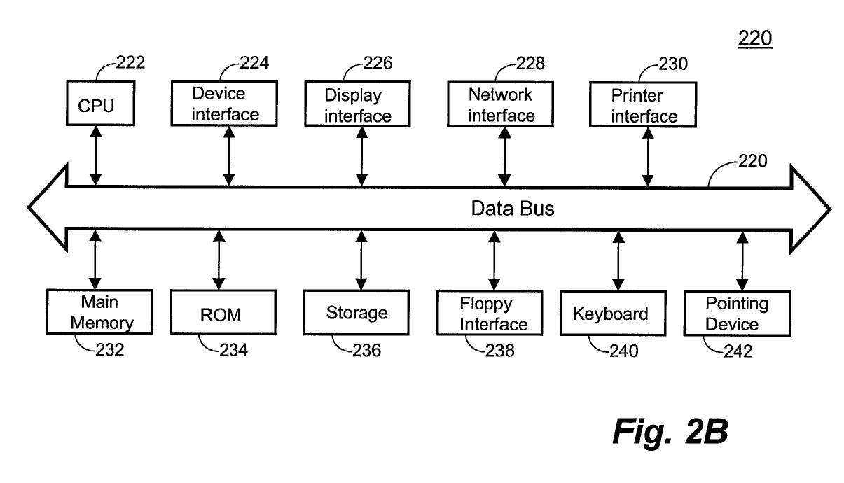

Referring to FIG. 2A, there is shown a functional block diagram of an information server 200 according to one embodiment of the present invention. Information server 200 may correspond to information server 114 of FIG. 1. As shown in FIG. 2A, server 114 comprises a phone network interface 202, a network interface 204 and a server module 210 along with a processor 206 and a storage space 208. Phone network interface 202 that may be a PSTN interface permits server 200 to communicate with a telephone over a voice link in a PSTN. In other words, phone network interface 202 exchanges voice signals between a telephone and server 200.

Network interface 204 facilitates a data flow between data network 116 and server 200 and typically executes special set of rules (e.g. a communication protocol) for the end points in a link to send data back and forth. One of the common protocols is TCP/IP (Transmission Control Protocol/Internet Protocol) commonly used in the Internet. Network interface 204 manages the assembling of a message or file into data packets that are transmitted over data network 118 and reassembles received packets into the original message or file. In addition, it handles the address part of each packet so that it gets to the right destination.

Server module 210 performs a series of functions as respectively described below. According to one aspect of the present invention, server 200 fetches pertinent information from data network 116 with respect to queries in real time or periodically generated from server module 210 in response to requests placed by callers.

In operation, a caller makes a call to server 200 over network 100, voice-to-text module 210 in server 200 converts a voice or audio signal from network 100 to a text signal. This may be done by a voice recognition system in or coupled to server 200. According to one embodiment, a voice recognition system is a commercial product including software and hardware. When an analog audio signal is received, the A/D converter in the voice recognition system converts the audio signal to a corresponding digital signal. Software in the voice recognition system is configured to recognize the digital signal from speech patterns in the digital signal with respect to a database in the voice recognition system. The database may include vocabulary, syntaxes and grammars. The output of the voice recognition system is a text that should be understandable to both human beings and a computer. An exemplary voice recognition system may be obtained from Nuance Communications, Inc. having a business address of 1005 Hamilton Court, Menlo Park, Calif. 94025.

Outputs, referred to herein as spoken texts, from voice-to-text module 206 are processed in text processing module 212 to produce standard texts that is fed to a database 214. According to one embodiment, database 214 maintains subscriber accounts that permit an administrator to manage and update subscriber information. Generally, a user or a subscriber can access some member-only services when a corresponding account is maintained in database 214. The corresponding account may include, but not limited to, personal information of the user, different levels of services, and account information. In one embodiment, a user account is associated with a voice portal page that is also maintained in database 214. The portal includes many items a user may frequently seek information thereof. The items may include, but not be limited to, news categories, a list of stock symbols, bookmarks, and a list of contacts. The portal is accessible and managed from a computing device coupled to a data network, wherein the computing device executes a browsing application.

In addition, many information categories, often frequently requested, containing sub-categories or detailed information is also maintained in database 214. As one of the features in the present invention, database 214 also includes a local searching data set that is generated, managed, and updated by data processing module 218. The local searching data set includes words or phrases to facilitate the generation of requests to be sent over network 116 for fetching requested information from one or more source servers on the network. For example, when a user speaks “ABC” in a news category, the word “ABC” is input to the local searching data that includes a matching word corresponding to the word “ABC”. For simplicity, the matching word is “ABC” as well and associated with “ABC NEWS”. When the two words match, a network request to get news from www.abcnews.com is generated in server module 210 and/or network interface 204. The request is an IP request conforming to a communication protocol in the network, such as an HTTP request, wherein HTTP is hypertext transfer protocol. The request includes “ABC NEWS”. As a result, information provided from www.abcnews.com is received. The implementation and operations of data processing module 218 as well as the generation of the local searching data 212 will be provided in more detail below.

After requested information is received from the network, text processing module 212 processes the requested information to facilitate the generation of a speech signal of the received information. In one situation, text processing module 212 removes extra words from the received information. For example, a received stock price may contain an asking price, a bidding price, current volume, previously closed price, day high and day low while a user who is requesting the information is only interested in the asking price. Accordingly, text processing module 212 will remove all except the asking price. The filtered information (i.e. the asking price) is input to text-to-voice module 208 that converts the text into a speech signal to be played to the user. The text-to-voice module in one embodiment is provided from Fonix Corporation having a business of 1225 Eagle Gate Tower, 60 East South Temple, Salt Lake City, Utah 84111.

As another feature of the present invention, server module 210 further includes frequency measurement module 216 that fetches most frequently requested information in advance and stores the pre-fetched information in database 214. As a result, server module 210 or network interface 204 will not be busy repeatedly generating network requests seeking the same information so as to avoid causing network traffic in the network.

According to one embodiment, an information reservoir is maintained in database 214. The information reservoir operates with frequency measurement module 216 and contains a plurality of information, each of pieces of the information is identified by an identifier, hence a group of identifiers are respectively associated with the information in the reservoir. Typically, the information in the reservoir is periodically, automatically, respectively updated with respective source servers.

As used herein, an identifier includes one or more words and is used as a label, a symbol, an icon, a file name or a representation of a piece of information. To facilitate the description of the present invention, an identifier may take more than one forms identifying a piece of information. For example, an identifier “GREENSPAN” and identifier “FED HIKING INTEREST AGAIN” mean the same article (i.e. information) provided by a source server. One may be used to name a file containing the information hosted in a source server feeder (e.g. located at www.newsagency.com). The other one may be used or spoken by a user. Regardless, the identifiers can be easily associated with each other. Those skilled in the art understand many ways to associate different identifiers to one piece of information if desired.

According to one embodiment, the information reservoir is organized under a list of identifiers, each of the identifiers linking to a corresponding piece of detailed information that is archived locally, e.g. in database 214. The entries (i.e. the identifiers) in the information reservoir are managed by frequency measurement module 216. In one implementation, a counter is configured to monitor requests from callers. When repeated requests for the same information is substantial, that means the information is highly demanding and of interest to the callers or subscribers. In operation, the counter exceeds a certain number, for example 20 during last 5 minutes, which means the information is being substantially demanding, an entry of an identifier identifying the information is entered in the information reservoir. Information associated with the entries in the information reservoir is automatically updated according to a schedule, for example, every 5 or 10 minutes. In other words, server module 210 is configured to generate respective network requests, each for one of the entries in the information reservoir. The requests are then sent respectively to servers that provide corresponding information. In return, server module 210 receives the corresponding information and archive the received information accordingly. As a result, when a new request is received from a caller who desires to listen to a piece of information that is considered being frequently requested, the new request can be locally fulfilled without accessing the network. In other words, the new request causes a retrieval of the particular information from database 214.

FIG. 2B shows an internal construction block of a computing system 220 in which the present invention may be implemented and executed. System 220 may correspond to a server device (e.g. server 114). System 220 includes a central processing unit (CPU) 222 interfaced to a data bus 220 and a device interface 224. CPU 222 executes certain instructions to manage all devices and interfaces coupled to data bus 220 for synchronized operations. Device interface 224 may be coupled to an external device such as a source server 100-1 hence requested information (i.e. in form of HTML) therefrom is received into memory or storage through data bus 220. Also interfaced or coupled to data bus 220 is display interface 226, network interface 228, printer interface 230 and floppy disk drive interface 238. Generally, a compiled and linked version of one embodiment of the present invention is loaded into storage 236 through floppy disk drive interface 238, network interface 228, device interface 224 or other interfaces coupled to data bus 220.

Main memory 232 such as random access memory (RAM) is also interfaced to data bus 220 to provide CPU 222 with the instructions and access to memory storage 236 for data and other instructions. In particular, when executing stored application program instructions, such as the complied and linked version of the present invention, CPU 222 is caused to manipulate the data to achieve results contemplated by the present invention. ROM (read only memory) 234 is provided for storing invariant instruction sequences such as a basic input/output operation system (BIOS) for operation of keyboard 240, display 226 and pointing device 242 if there are any.

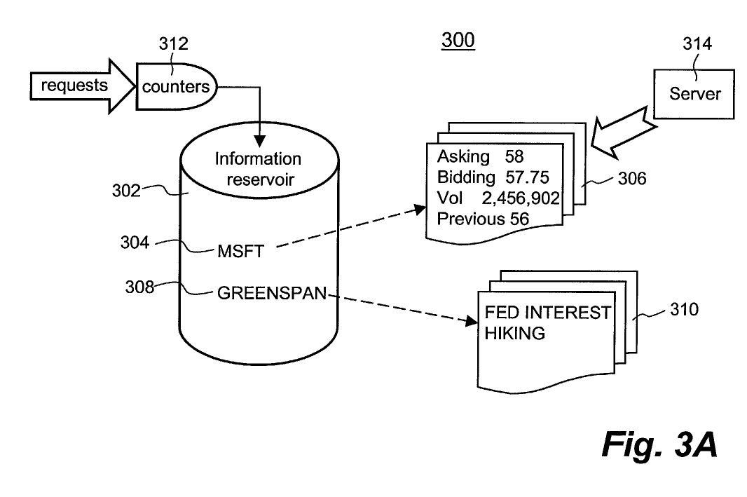

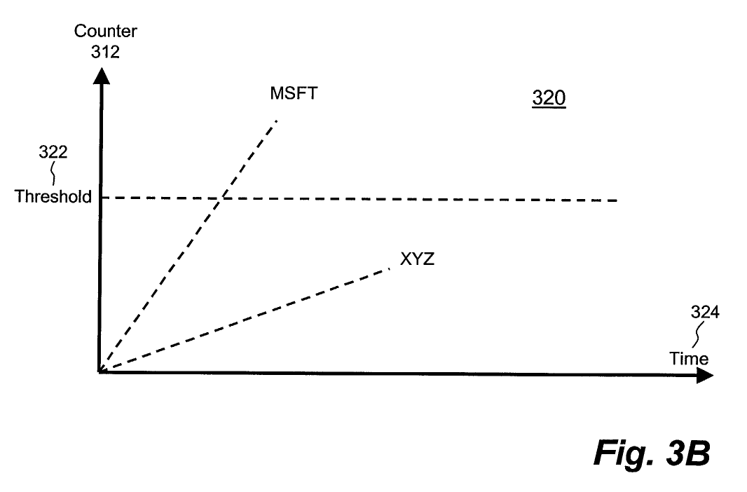

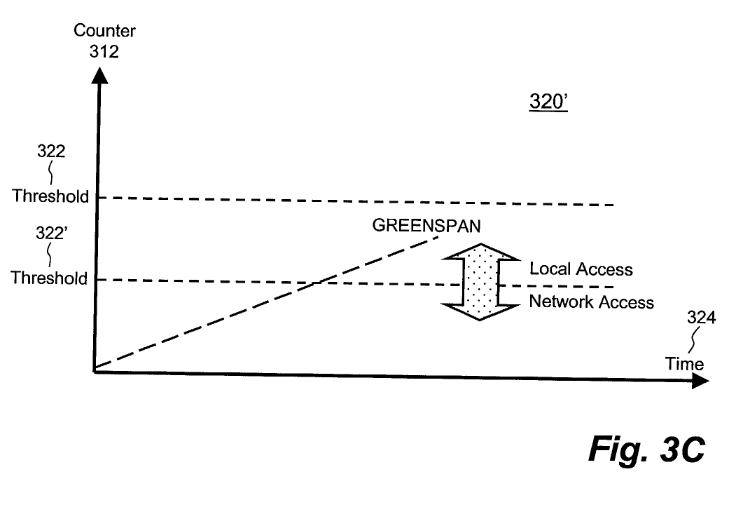

FIG. 3A illustrates an exemplary information reservoir 302 according to one embodiment. Information reservoir 302 maintains a list of identifiers (e.g. 304 and 308) that are frequently requested by callers. As an example, two of counters 312 have been activated to monitor two identifiers “MSFT” 304 and “GREENSPAN” 308 in information reservoir 302 after the counters determine respectively that there are enough requests received to justify that pieces of information identified by “MSFT” 304 and “GREENSPAN” 308 shall be archived locally. More specifically, a stock with a symbol “MSFT” is being very active in a day and many callers have requested the stock price information of “MSFT”. Likewise, a federal reserve meeting is in session and many subscribers may desire to know if any interests would be changed. Hence the news about the federal reserve meeting is identified by “GREENSPAN”.

In operation, there are two different ways to enter the identifiers “MSFT” and “GREENSPAN” in information reservoir 302. Identifier “MSFT” 304 is activated due to high demanding from the users. Many calls have been received during a predefined period, the counter activates identifier 304 so that detailed information 306 by the identifier can be pre-fetched from a server 314 supplying detailed information 306. To keep detailed information 306 updated, information reservoir 302 is configured to send a network request to server 314 according to a schedule (i.e. every 20 min). In response to the network request, server 314 transports the request information to update detailed information 306 in the reservoir. Hence requests from all callers for the detailed information of MSFT stock can be fulfilled locally, namely a retrieval of detailed information 306 is performed with the reservoir in response to the requests. As will be described below, the identifiers (e.g. words in each of the identifiers) in the information reservoir can be also used to minimize ambiguities between two words, phrases, symbols, and identifiers that might be pronounced indistinctly.

FIG. 3B illustrates a diagram 320 of counter vs. time. A threshold 322 may be manually decided. Counter 312 checks the received requests from the users. When a counter for “MSFT” exceeds threshold 322, the identifier “MSFT” is entered into the reservoir. Same or different threshold 322 may be applied to another identifier “XYZ”. A second counter is also used to monitor the identifier. As shown in the figure, the number of requests for “XYZ” does not exceed threshold 322, hence “XYZ” is not to be placed in the information reservoir. In this case, each of the requests for “XYZ” will be processed separately and a corresponding network request thereof is generated to fetch corresponding information identified by “XYZ” from a server over the network.

The number of requests for “GREENSPAN” 308 in FIG. 3A may not exceed a threshold as shown in FIG. 3C. One of the reasons may be that no one would call for the detailed information before the end of the on-going federal reserve meeting. However, it can be foreseeable that the number of requests from the user could be skyrocketing as soon as a rumor spreads in the street that the meeting is just finished. The information server 200 could instantly experience a substantial number of requests from its subscribers for the news. Such sudden burden to information server 200 may exceed its capacity. As another one of the features in the present invention, the counter can be readjusted to activate the entry of an identifier into the information reservoir. There are a number of ways to implement the activation. One of the ways is simply a manual entry of one or more identifiers by an administrator of the server in anticipation of high demands for information respectively identified by the one or more identifiers. FIG. 3C shows an example in which threshold 322 is artificially lowered down to threshold 322′ so that identifier “GREENSPAN” becomes qualified to be entered into the information reservoir. For example, instead of requiring 10 requests for the identifier within 5 minutes, now 3 requests within 3 minutes for the identifier may qualify the identifier to be entered into the information reservoir.

Another implementation involves an automatic notification from a feeding server that provides the information that can be potentially highly demanded. An arrangement between the information server and the feeding server may be arranged in advance. When the feeding server determines that a category subscribed or demanded by the information server will be of highly interest to the subscribers of the information server, a notification is sent from the feeding server to the information server. Upon receiving the notification, the information server determines if it is necessary to fetch the information into its information reservoir. If yes, the server module in the information server sends a request in response to the notification to the feeding server to fetch detailed information in the category.

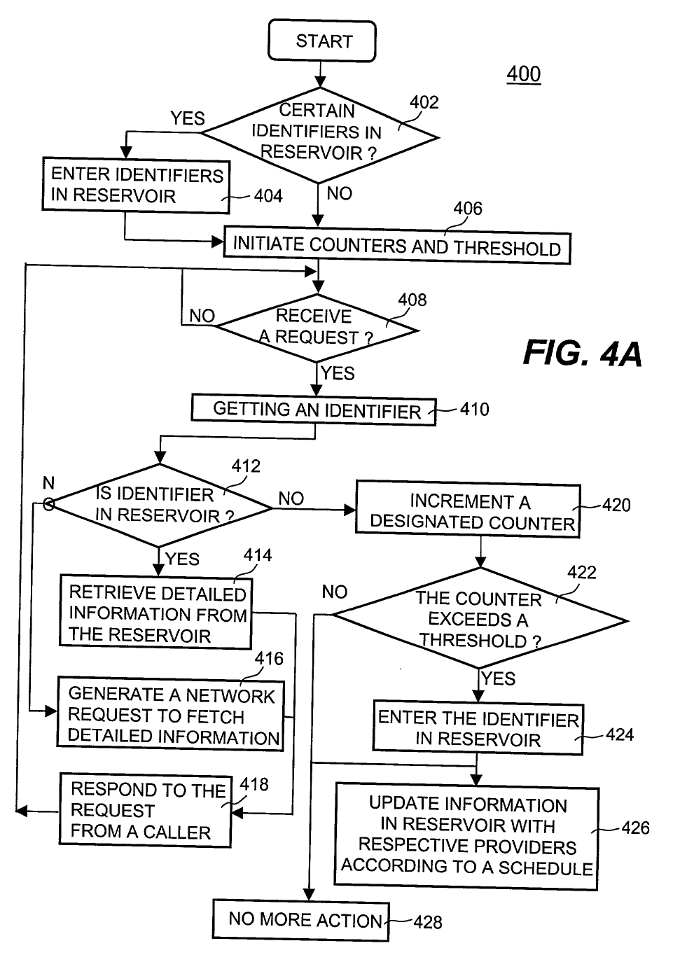

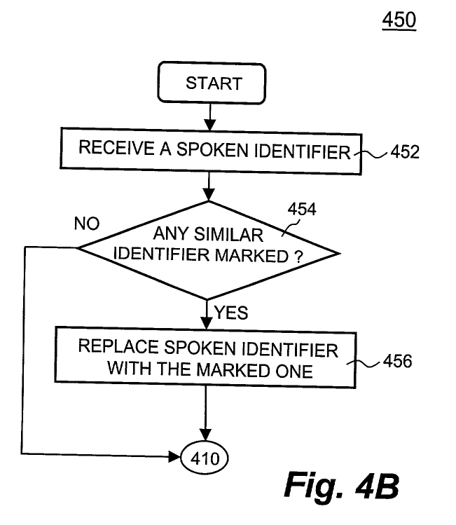

FIG. 4A shows a flowchart of a process 400 according to one embodiment of the present invention. Process 400 may be implemented as a method, an apparatus, a software product and other forms to be deployed in a server providing voice interactive services to subscribers/users. In a preferred embodiment, process 400 is implemented in a server module, for example, server module 210 of FIG. 2A. Process 400 shall be understood in conjunction with preceding figures.

Typically a server providing voice interactive services is initially determined if there are any particular information that shall be locally archived. At 402, identifiers identifying the particular information are respectively identified. For example, daily news, regardless of any requests therefor, may need to be locally archived. A piece of domestic news may be identified by “DNEWS” and a piece of world news may be identified by “WNEWS”. The same news could be requested by “local news” or “world news” over the voice line. Herein “DNEWS” and “WNEWS” are respectively associated with spoken texts “local news” or “world news” but in a simpler form to identify two corresponding files containing the actual news information. The identifiers “local news” or “world news” are then entered into an information reservoir that is preferably locally accessible at 404. According to one embodiment, each of the entered identifiers includes a “file” identifier and an address identifying a server from which identified information can be fetched. The address may be an IP address. The “file” identifier (simply referring to as identifier) may be a file name of the identified information. If the identified information is in HTML format, the file name may be DNEWS.html or WNEWS.html to follow the above example. It should be noted that it is not required to have the identifier in a local server to be identical to the name of the file in a remotely located feeding server. In fact, any naming can be used as long as they correspond to each other so that only identified information will be located and fetched.

If there are identifiers to be considered at 402 or after a selected number of identifiers are entered in the information reservoir, process 400 goes to 406 to initialize a number of counters and respective thresholds at 406. Generally, a counter is initialized to zero from which the counter increments every time there is an incident to the account. However, it is possible to initialize one or more counters to be other than zero to account for some special messages or information users would highly demand for in a given time. The thresholds may be manually determined depending on an actual situation. For example, a threshold for a particular stock symbol is adjusted particularly low for a few days, as an earning report thereof will be released on one of the days. The purpose is to qualify this particular stock faster to be entered into the information reservoir so that subsequent requests for the same stock symbol could be fulfilled locally. Likewise, the threshold for the same stock symbol can be adjusted very high to disqualify the entry or show a real justification to enter the stock into the information reservoir.

At 408, a request is received from a caller. As described above, the request is derived from one or more spoken commands from a caller. At 410, an identifier is extracted from the request. Typically, a request includes one or more words making the identifier. In one situation, the request is identical to the identifier, such as “MSFT” when the caller is requested to speak a symbol of a stock being interested. In another situation, the request includes some extra words in addition to the identifier, such as “today's world news” when the caller is requested to speak what kind of news he/she is looking for. If the identifier being sought is “world news”, then the extra words will be filtered out before the identifier is obtained. Optionally for an efficient implementation, the identifier may be mapped to “WNEWS” for easy fetching from a feeding server or local retrieval. In this case, the first identifier is referred to as spoken identifier and the mapped identifier is referred to as actual identifier typically used in a network request for fetching identified information thereof. In yet another situation, the request includes words less than what a spoken identifier should have. For example, when referring to a local well-known restaurant, people usually do not speak the name in its entirety, rather a shortened version thereof, such as “Paolo's Restaurant” as “Paolo's”. The actual identifier must be constructed from the spoken version. The detailed description of constructing an actual identifier from the spoken version will be provided below.

After the identifier is obtained, it is checked to see if the identifier has a corresponding one in the information reservoir at 412. When it is determined that the identifier matches in the information reservoir, locally archived information identified by the identifier is retrieved at 414. The retrieved information is then sent to the caller at 418 in response to the request received at 408. If it turns out that the identifier does not have a match in the information reservoir at 414, the server module generates a network request at 416. The network request includes the identifier and a corresponding address (e.g. an IP address) to fetch the identified information from a server identified by the address. The fetched information is then sent to the caller at 418 in response to the request received at 408.

Referring now back to 412, after it is determined that the identifier has no corresponding entry in the information reservoir, a counter therefor increments per the identifier at 420. The counter may be just assigned or is designated to the identifier depending on how many times the identifier has requested. At 422, the counter is checked to see if it exceeds a threshold. The threshold is one of the criteria that may qualify the identifier to be entered in the information reservoir. Typically, when the counter is higher, that means the demand for the identified information is high, which justifies the local reservation of the identified information. After determining that the counter does exceed the threshold or other particular reasons, the identifier is entered into the information reservoir at 424. To ensure that callers always get the latest requested information, the information reservoir is periodically updated at 426 with reference to the respective identifiers thereof.

As another feature of the present invention, an archived identifier is used to minimize ambiguities between two identifiers that might be pronounced indistinctly. Sometimes, a user may not pronounce a word or title incorrectly or two words/phrases do sound similarly, a voice recognition system may output a text slightly different from the actual text. The archived identifier may be used to correct the spoken text. For example, words “too” and “two”, “pair” and “pear”, “air” and “ear” could be all pronounced indistinctly. In stock symbols, they are many symbols that could be hardly distinct by pronunciation. It is rather difficult for a voice/speech recognition system to distinguish such pair unless the contexts are referred to (while in stock symbols, the context is hardly available). FIG. 4B shows a flowchart of a process 450 that can be implemented to minimize ambiguities between two words, symbols, phrases, or identifiers that might be pronounced indistinctly. Process 450 may be implemented as a method, an apparatus, a software product and other forms to be deployed in a server providing voice interactive services to subscribers/users. In a preferred embodiment, process 450 is implemented in a server module, for example, server module 210 of FIG. 2A. Process 400 shall be understood in conjunction with FIG. 4A.

As described above, after 424, the information reservoir contains a plurality of identifiers, some are entered as a result of users' high demands and others are entered due to a physical adjustment of the threshold to anticipate a high demand thereof or other reasons. According to one aspect of the present invention, the other reasons is to improve overall accuracy of the voice interactive system by minimizing ambiguities between two words, symbols, phrases, or identifiers that might be pronounced indistinctly and result in incorrectly identified information.

At 452 a spoken identifier is received from, for example, a voice recognition system that has received a speech signal from a caller. In accordance with FIG. 4B, the spoken identifier is a spoken version of an actual identifier. In some cases, the voice recognition system may output a confidence coefficient that indicates how accurate the spoken version has been recognized. The confidence coefficient may trigger a verification of the spoken identifier. It should be noted that often one or more words in an identifier could be pronounced indistinctly. It is now evident to those skilled in the art that a counter used to track the occurrence of an identifier is equally applied to the tracking of the occurrence of a word. Regardless, it can be assumed that a list of words or identifiers have been marked (or collected in the information reservoir) to assist the minimization of any ambiguities between two similar words.

At 454, the list is looked up for a similarity match to the spoken word or identifier received from 452. A similarity match is used herein to indicate that there are two words or identifiers that could be either pronounced substantially similarly or spelled substantially similarly. For example, there is a similarity match between words “too” and “two”, “pair” and “pear”, “air” and “ear”. If the list turns out that no word therein could have a similarity match to the spoken word or identifier received from 452, process 450 goes to 410 of FIG. 4A. If the list turns out that there is a word that has a similarity match to the spoken word or identifier received from 452, the word in the list is to replace the spoken word or identifier at 456. As a result, a correct word or identifier is obtained to facilitate process 400 of FIG. 4A.

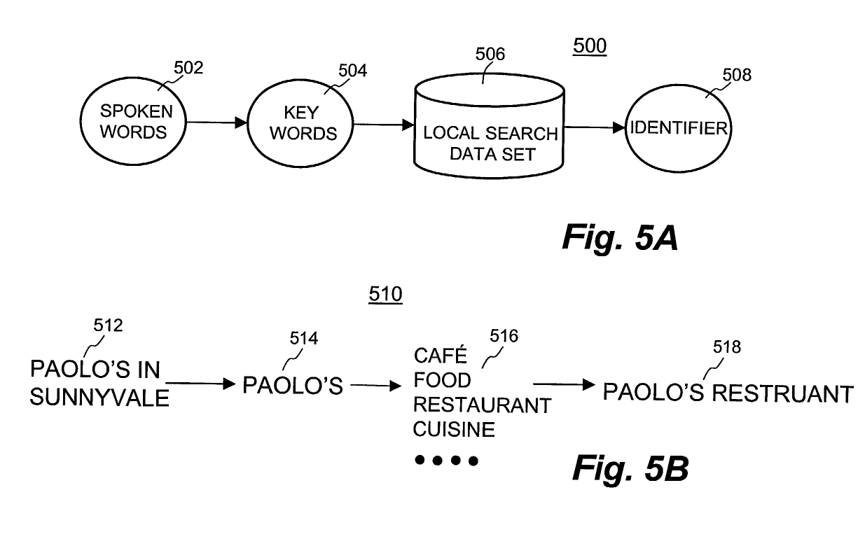

Referring to FIG. 5A, there is shown a functional diagram 500 of generating an identifier from spoken words 502 by a caller. Spoken words 502 are generally an output from a text processing module and contain one or more words. Keys words 504 are derived from spoken words 502 and typically include less (or equal) number of words than spoken words 502 contain. Keys words 504 are then input to local search data set 506 to form a complete identifier 508. The identifier can be used to exactly identify what the caller looks for.

FIG. 5B illustrates an example 510 in which the spoken words are “Paolo's in Sunnyvale”. When a caller is looking for information about a restaurant named “Paolo's Restaurant”, perhaps to make a reservation, he/she is likely to ignore the generic word “Restaurant”. After a text processing, and secondary or auxiliary words, such as in “Sunnyvale” are removed, leaving only the key words “Paolo's”. Through a local search data set, generic word or words that are relevant to the key words are added in a linguistic sense, resulting in an identifier comprising the complete words set.

As seen from FIG. 5A, function diagram 500 requires a local search data set that is typically generated from titles, names, slogans, each identifying a piece of information provided by a server via the information server. Preferably, under distinct categories, each of the pieces of information in a category is identified by an identifier that can be one of the titles, names, slogans.

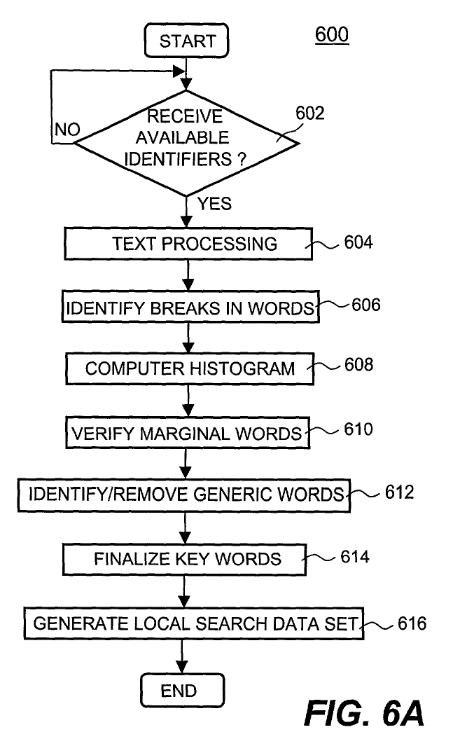

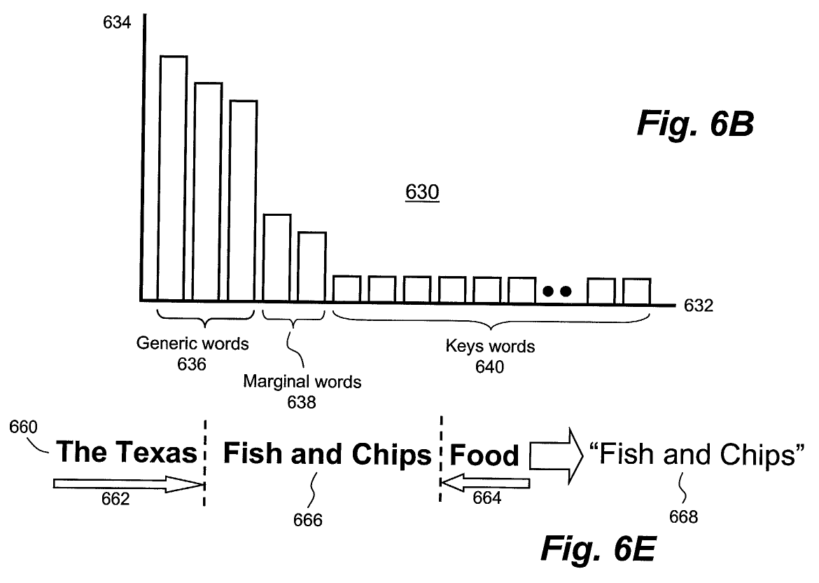

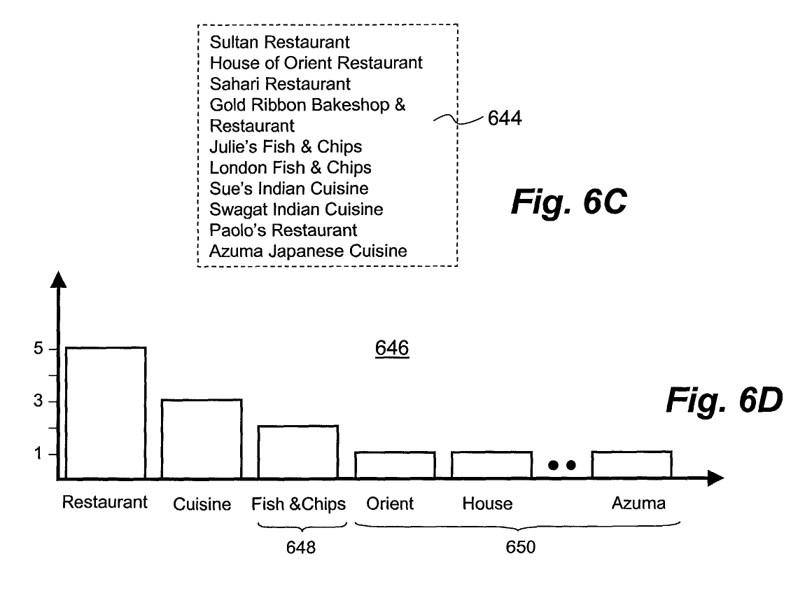

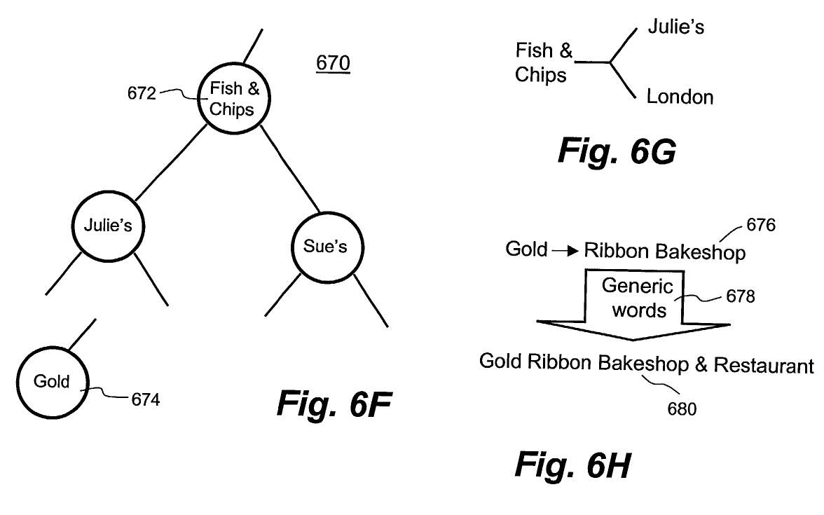

FIG. 6A shows a flowchart of a process 600 to generate a local searching data set and shall be understood in conjunction with FIGS. 6B-6E together with the preceding figures. Process 600 may be implemented as a method, an apparatus, a software product and other forms that can be deployed in a server providing voice interactive services to subscribers/users. In a preferred embodiment, process 600 is implemented in a server module, for example, as data processing module 218 of FIG. 2A.

At 602, process 600 is initiated to receive all identifiers (i.e. the corresponding information) that a voice interactive server is configured to provide. Typically, a server is designed to provide a limited number of information categories, such as News, Sports, Weather, Greetings, Calendar, Bookmark, Address Book, Directions and Inquiries. Under each of the categories, there are a limited number of sub categories. According to one embodiment, process 600 is repeatedly executed for each of the categories, subcategories, sub-sub-categories, or a given group. If a given group is configured to have N kinds of information available for a user to listen to, there may be N identifiers, each identifying one kind of the information. Generally, the identifiers are provided by a feeding server that hosts, manages, updates identified information. Hence process 600 is to check at 602 if there are any or N identifiers available for the process to proceed. When there are identifiers available, process 600 goes to 604.

At 604, the received identifiers are processed. One of the purposes at 604 is to remove uncommonly used symbols in an identifier if there are any. For example, an economic news title, used as an identifier, is “[MSFT] MICROSOFT Challenged”. The actual title is “MICROSOFT Challenged” while the prefix “[MSFT]” is intentionally provided to the investment community with the corresponding stock symbol. From an information search or library archival perspective, the prefix is not necessary. Hence after 604, such prefix is filtered out. It should be noted that it is not possible to list all possible removable symbols or words herein, as they are very much depending on the information category. One word or symbol is considered removable in one category while becoming a key word in another category. One of the important functions provided by 604 is to facilitate the efficient operation of process 600.

As described above, one of the purposes at 604 is to remove uncommonly used symbols with reference to one particular category. In addition, depending on an actual meaning, a symbol is sometimes replaced with a word, for example; “Fish & Chips”, in which symbol “&” can be replaced with a word “and”. The implementation of this process may be done through a look-up-table.

At 606, a filtered identifier is examined to locate the breaks between words or symbols. A histogram is computed at 608 for all of the identifiers from 606. FIG. 6B shows a histogram 630 computed from a group of identifiers, each including one or more words or symbols. Horizontal line 632 of histogram 630 indicates every distinct word in the group of identifiers and vertical line 634 of histogram 630 indicates the number of times of a word appeared in the group of identifiers. FIG. 6C shows a group of actual identifiers 644 under a restaurant category. Each of the identifiers 644 is a restaurant name that may lead to detailed information about the restaurant, a direction to get there, a menu of house specialties or perhaps a reservation line. When a histogram of identifiers 644 is computed, the corresponding histogram 646 is shown in FIG. 6D. As is shown, there are 5 occurrences for “restaurant”, 3 occurrences for “cuisine”, 2 occurrences for “Fish & Chips”, and 1 occurrence for the rest of the words.

Referring FIG. 6B in view of FIG. 6D, those words that occur the most are considered generic words while those words that occur the least are considered key words. It may be understood by now that the key words, or their combinations if combined correctly, provide the most information about the nature of the information being identified. In the restaurant category, for example, “Azuma” indicates a specific name of a restaurant. On the other side, the generic words do not provide too much useful information, such as “restaurant” or “cuisine” in the restaurant category. Histogram 630 shows that there are some marginal words 638. The marginal words appear in a “gray” area of the histogram, meaning that a clear cut between the generic and key words is not straightforward. At 610, the marginal words must be grouped into either the generic words group or the key words group.

According to one embodiment, a manual inspection is provided. Marginal word 648 in histogram 646 is grouped into key words group 650 after such manual inspection is performed. Another possible way to decide which group the marginal words shall belong to is to base on its linguistic meanings. If the meaning of a marginal word is close to what the generic words mean, the marginal word is grouped into the generic words group, otherwise into the key words group.

Sometimes, some of the key words are regrouped out of the grouping of the marginal words. Conjunction words, such as “and” could be often fall into the marginal words group. Still another way to group such marginal words is to go back to the original identifier to see if it is necessary to combine one or more key words to form a combined key words. FIG. 6E shows an identifier 660 “The Texas Fish and Chips Food” reformatted from “The Texas Fish & Chips Food”. A directional search (i.e. from right to left 662 and from left to right 664) is performed. When a search is from right to left 662, words are verified with the generic words group and the key words group. If a word in identifier 660 is one of the generic words, search 662 proceeds till a key word is hit. The same approach is applied to search 664 from left to right. With the margin word “and” 666, key words on both sides are verified to see if it is meaningful to combine the keywords together with the marginal word to form a combined key word. Quite often with a conjunction word, it is very likely to generate a combined key word. As a result, combined key word 668 is generated. With the newly generated combined key word 668, the marginal word “and” is diminished.

Once the generic words are finalized from 610, the generic words are removed at 612, thus leaving only the key words (including any possible combined key words). The key words are organized in a logic way that would form part of the original identifier. Hence a local search data set is formed. According to one embodiment, a local search data set is organized as a tree structure suitable for efficient searching. FIG. 6F shows an exemplary portion 670 of a tree structure for the keywords of identifiers 644. It is assumed that a caller spoke only “Fish & Chips” that is input to the tree structure for matching. A node 672 has a corresponding key word (or combined key word), hence a tree search known to those skilled in the art will lead to node 672. Record information of the node shows that there are two restaurants that could be referred to as “Fish & Chips” in this category or a defined city or region as shown in FIG. 6G. In operation, the called will be prompted for a clarification as to which restaurant the caller might be referring to.

If the spoken text from a caller is “Gold”, the tree structure is again searched. Eventually, a node 674 containing the corresponding matching word is located. A corresponding record of the node is further examined as shown in FIG. 6H. Associated key words 676 are retrieved and “stitched” accordingly. The stitched key words are then to go through a generic words process 678 to complete an identifier “Gold Ribbon Bakeshop & Restaurant” 680. The finished identifier points to detailed information about the restaurant the caller is trying to find out. It should be noted that the identifier in this example is to recover a complete title or name of a business entity. Those skilled in the art can understand that the description is equally applied to other forms of identifiers, for example, a title, a name, a filename, a symbol, an IP address and a short article.

The invention described herein may be implemented as a method, an apparatus, a system or a software product. The processes, sequences or steps and features disclosed in the present invention are related to each other and each is believed independently novel in the art. The disclosed processes, sequences or steps and features may be performed alone or in any combination to provide a novel and unobvious system or a portion of a system.

At least portions of the invention can be embodied as computer readable code on a computer readable medium. The computer readable medium is any data storage device that can store data that can be thereafter read by a computing device. Examples of the computer readable medium include read-only memory, random-access memory, disk drives, floppy disks, CD-ROMs, DVDs, magnetic tape, optical data storage devices, carrier waves. The computer readable media can also be distributed over network coupled computer systems so that the computer readable code is stored and executed in a distributed fashion.

The present invention has been described in sufficient detail with a certain degree of particularity. It is understood to those skilled in the art that the present disclosure of embodiments has been made by way of examples only and that numerous changes in the arrangement and combination of parts may be resorted without departing from the spirit and scope of the invention as claimed. While the embodiments discussed herein may appear to include some limitations as to the presentation of the information units, in terms of the format and arrangement, the invention has applicability well beyond such embodiment, which can be appreciated by those skilled in the art. Accordingly, the scope of the present invention is defined by the appended claims rather than the forgoing description of embodiments.

1. A method for matching a spoken text, the method comprising:
receiving the spoken text from a voice recognition system that converts a voice signal to the spoken text;
looking up for one or more words that match the spoken text, wherein the one or more words are derived from an identifier of a piece of information provided from a server is coupled over a data network; and
retrieving the information either from the server or a local database with respect to the identifier as a query to the server or the database.

2. The method of claim 1, wherein the server is remotely located and provides the information upon receiving a request including the identifier.

3. The method of claim 2 further comprising:
generating the request to include the identifier; and
sending out the request over the data network.

4. The method of claim 3, wherein the data network includes one of (i) the Internet, (ii) the Intranet, (iii) a wireless network, and (iv) a network of a private and a public network.

5. The method of claim 4, wherein the voice signal is received from a voice network and input to the voice recognition system.

6. The method of claim 5, wherein the voice network includes one or more of a public switched telephone network (PSTN) and a wireless network.

7. The method of claim 3, wherein the looking up for one or more words comprises:
receiving the identifier from the server, wherein the identifier contains more than one words;
extracting one or more key words from the identifier; and
archiving the one or more key words in a local searching data set, wherein the local searching data set is remotely separated from the server.

8. The method of claim 7, wherein the extracting of the one or more key words from the identifier comprises discarding generic words from the identifier, wherein the generic words can be included in other identifiers.

9. The method of claim 7, wherein the extracting of the one or more key words from the identifier further comprises:
computing a histogram of the identifier; and
identifying the generic words and the key words.

10. The method of claim 1, wherein the retrieving of the information comprises obtaining the information from the local database if the local database archives a copy of the information, otherwise from the server.

11. A method for matching a spoken text, the method comprising:
receiving a plurality of identifiers, each of the identifiers indicating a piece of information;
identifying generic words and key words from the identifiers; and
organizing the keywords in a structure that can facilitate matching of the spoken text to one of the keywords.

12. The method of claim 11 further comprising storing the structure in a local database.

13. The method of claim 12, wherein the structure is based on a data structure designated from searching through with respect to a query.

14. The method of claim 13, wherein the structure is a tree structure, each node of the tree structure being one of the keywords and associated with one or more of the key words that are collectively from one of the identifiers.

15. The method of claim 11, wherein each of the identifiers contains one or more words and is selected from a group consisting of a title, a filename, a symbol, an IP address and a short article.

16. The method of claim 15, wherein the identifiers are supplied from a server providing information, each of pieces of the information being identified by one of the identifiers.

17. The method of claim 16, wherein the server is remotely located over a data network, and the identifiers are provided over the data network.

18. The method of claim 11, wherein the identifying of the generic words and the key words comprises:
computing a statistic measurement of the identifiers; wherein the statistic measurement indicating how often each of the generic words and the key words has respectively occurred in the identifiers; and
classifying the generic words and the key words from the statistic measurement.

19. The method of claim 18, wherein the computing of the statistic measurement of the identifiers is computing a histogram of the identifiers.

20. The method of claim 19, wherein the classifying of the generic words and the key words comprises:
identifying any marginal words from the identifiers with respect to the histogram;
performing an linguistic analysis of the marginal words to group the marginal words with either the generic words or the key words.

21. A product including computer instructions to be executed in a computing device, the product comprising:
program code for receiving the spoken text from a voice recognition system that converts a voice signal to the spoken text;
program code for looking up for one or more words that match the spoken text, wherein the one or more words are derived from an identifier of a piece of information provided from a server is coupled over a data network; and
program code for retrieving the information either from the server or a local database with respect to the identifier as a query to the server or the database.

22. The product of claim 21, wherein the server is remotely located and provides the information upon receiving a request including the identifier.

23. The product of claim 22 further comprising:
program code for generating the request to include the identifier; and
program code for sending out the request over the data network.

24. The product of claim 23, wherein the data network includes one of (i) the Internet, (ii) the Intranet, (iii) a wireless network, and (iv) a network of a private and a public network.

25. The product of claim 24, wherein the voice signal is received from a voice network and input to the voice recognition system.

26. The product of claim 25, wherein the voice network includes one or more of a public switched telephone network (PSTN) and a wireless network.

27. The product of claim 23, wherein the program code for looking up for one or more words comprises:
program code for receiving the identifier from the server, wherein the identifier contains more than one words;
program code for extracting one or more key words from the identifier; and
program code for archiving the one or more key words in a local searching data set, wherein the local searching data set is remotely separated from the server.

28. The product of claim 27, wherein the program code for extracting the one or more key words from the identifier comprises discarding generic words from the identifier, wherein the generic words can be included in other identifiers.

29. The product of claim 27, wherein the program code for extracting the one or more key words from the identifier further comprises:
program code for computing a histogram of the identifier; and
program code for identifying the generic words and the key words.

30. The product of claim 21, wherein the program code for retrieving the information comprises program code for obtaining the information from the local database if the local database archives a copy of the information, otherwise from the server.

31. A product including computer instructions to be executed in a computing device, the product comprising:
program code for receiving a plurality of identifiers, each of the identifiers indicating a piece of information;
program code for identifying generic words and key words from the identifiers; and
program code for organizing the keywords in a structure that can facilitate matching of the spoken text to one of the keywords.

32. The product of claim 31 further comprising program code for storing the structure in a local database.

33. The product of claim 32, wherein the structure is based on a data structure designated from searching through with respect to a query.

34. The product of claim 33, wherein the structure is a tree structure, each node of the tree structure being one of the keywords and associated with one or more of the key words that are collectively from one of the identifiers.

35. The product of claim 31, wherein each of the identifiers contains one or more words and is selected from a group consisting of a title, a filename, a symbol, an IP address and a short article.

36. The product of claim 35, wherein the identifiers are supplied from a server providing information, each of pieces of the information being identified by one of the identifiers.

37. The product of claim 36, wherein the server is remotely located over a data network, and the identifiers are provided over the data network.

38. The product of claim 31, wherein the program code for identifying of the generic words and the key words comprises:
program code for computing a statistic measurement of the identifiers; wherein the statistic measurement indicating how often each of the generic words and the key words has respectively occurred in the identifiers; and
program code for classifying the generic words and the key words from the statistic measurement.

39. The product of claim 38, wherein the program code for computing the statistic measurement of the identifiers is computing a histogram of the identifiers.

40. The product of claim 39, wherein the program code for classifying the generic words and the key words comprises:
program code for identifying any marginal words from the identifiers with respect to the histogram;
program code for performing an linguistic analysis of the marginal words to group the marginal words with either the generic words or the key words.
